(19) United States
(12) Patent Application Publication
(10) Pub. No.: US 2026/0311075 A1
(43) Pub. Date: Oct. 8, 2026

(54) Methods And Systems For Use In Resource Allocation In Growing Facilities

(71) Applicant: MONSANTO TECHNOLOGY LLC, Saint Louis, MO (US)

(72) Inventors: Ronald G. ASKIN, Phoenix, AZ (US); Dave BAITINGER, Ogden, IA (US); Jennifer BECKER, Muscatine, IA (US); Bradley HART, Tucson, AZ (US); Shrikant JARUGUMILLI, O'Fallon, MO (US); Elizabeth Erin JELIC, Tucson, AZ (US); Anirudha KULKARNI, O'Fallon, MO (US)

(21) Appl. No.: 19/480,337

(22) PCT Filed: Apr. 30, 2024
(86) PCT No.: PCT/US2024/026991

§ 371 Date: Oct. 30, 2025

Related U.S. Application Data
(60) Provisional application No. 63/463,264, filed on May 1, 2023.

(51) Int. Cl. G06Q 10/0631

(52) U.S. Cl. CPC G06Q 10/0631

(57) ABSTRACT

Example systems and methods are disclosed for allocating resources in a growing facility. On example computer-implemented method includes, in response to an instruction, accessing data representative of a growing facility and data representative of a product to be introduced into the growing facility, where the growing facility includes multiple greenhouses and the product includes multiple growth stages. The method also includes determining a facility scheme, in which ones of the multiple growth stages are assigned to ones of the multiple greenhouses, based on the accessed data and an objective function, and implementing the facility scheme at the growing facility.

### CROSS-REFERENCE TO RELATED APPLICATION

This application claims the benefit of, and priority to, U.S. Provisional Application No. 63/463,264, filed on May 1, 2023. The entire disclosure of the above-referenced application is incorporated herein by reference.

### FIELD

The present disclosure generally relates to methods and systems for use in allocating resources in crop advancement growing spaces, and, in particular, to methods and systems for use in allocating resources of a plant growing facility to different growth stages associated with plants disposed in the plant growing facility.

### BACKGROUND

This section provides background information related to the present disclosure which is not necessarily prior art.

In plant development, plants are modified through various mechanisms, including selective breeding, genetic modification, etc., to exhibit desirable traits. Seeds and/or plants resulting from the modifications are tested to determine the success of the modifications. In connection therewith, it is known to provide a growing facility, in which the seeds are planted, grown, managed and harvested, whereupon the testing of the seeds and/or plants may be implemented. When the modifications are successful, the plants may be promoted for further development or for commercialization.

### SUMMARY

This section provides a general summary of the disclosure, and is not a comprehensive disclosure of its full scope or all of its features.

Example embodiments of the present disclosure generally relate to computer-implemented methods for allocating resources in a growing facility. One example method includes: in response to an instruction, accessing, by a computing device, data representative of a growing facility and data representative of a product to be introduced into the growing facility, the growing facility including multiple greenhouses, the product including multiple growth stages; determining, by the computing device, a facility scheme, in which ones of the multiple growth stages are assigned to ones of the multiple greenhouses, based on the accessed data and an objective function; and implementing, by the computing device, the facility scheme at the growing facility.

Example embodiments of the present disclosure also relate to non-transitory computer-readable storage media including executable instructions for allocating resources in a growing facility. In one example embodiment, such a non-transitory computer-readable storage medium includes executable instructions, which when executed by at least one processor, cause the at least one processor to perform one or more of the above operations and/or one or more of the operations described herein. For instance, in one example embodiment, the non-transitory computer-readable storage medium includes executable instructions, which when executed by at least one processor, cause the at least one processor to: in response to an instruction to the at least one processor, access data representative of a growing facility and data representative of a product to be introduced into the growing facility, the growing facility including multiple greenhouses, the product including multiple growth stages; determine a facility scheme, in which ones of the multiple growth stages are assigned to ones of the multiple greenhouses, based on the accessed data and an objective function; and implement the facility scheme at the growing facility.

Example embodiments of the present disclosure also relate to systems for allocating resources in a growing facility. In one example embodiment, such a system includes at least one computing device configured to: (i) in response to an instruction, access data representative of a growing facility and data representative of a product to be introduced into the growing facility, the growing facility including multiple greenhouses, the product including multiple growth stages; (ii) determine a facility scheme, in which ones of the multiple growth stages are assigned to ones of the multiple greenhouses, based on the accessed data and an objective function; and (iii) implement the facility scheme at the growing facility. In addition, in some examples, the system may further includes the growing facility. And, in some further examples, the growing facility includes at least one greenhouse.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is an example system of the present disclosure for use in determining facility schemes for a growing facility, whereby resources of the growing facility are assigned to particular growth stages in connection with growing, developing, etc. plants at the growing facility;

FIG. 2 illustrates an example growing facility, which may be included in the system if FIG. 1;

FIGS. 3-5B illustrate example details of the growing facility of FIG. 2;

FIG. 6 is a block diagram of an example computing device that may be used in the system of FIG. 1; and

FIG. 7 is an example method, suitable for use with the system of FIG. 1, for determining a facility scheme for a growing facility in connection with growing, developing, etc. plants at the growing facility, whereby resources are assigned to particular growth stages of the plants.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

For a specific growing facility, allocation of the resources, such as, for example, greenhouses, etc., to different products (e.g., seeds, plants, etc.), stages, etc., is important to the success of the growing facility. For example, throughput of the growing facility may indicate a number of products advancing through the growing facility (e.g., being processed therein, etc.), from seed planting to harvest. The growing facility, and in particular, workstations, capacities, movement constraints, etc. associated with the facility, however, provide(s) physical limitations on the throughput of the growing facility. At the same time, biological attributes, characteristics, etc. of the products at the growing facility may define specific time periods during which the products are planted, replanted, pollinated, moved to different environments, etc. as part of growing and harvesting. In combination, the complex interaction of the above variables, attributes, characteristics, etc., especially for a commercial growing facility, requires evaluation, in manners that are beyond the human mind to solve, to improve throughput of the growing facility (and/or provide desired throughput for the growing facility). In contrast, conventional planning of growing facility schemes rely on human decisions (e.g., related to timing, etc.) without considering readily available information, which often leads to subjective schemes at the growing facility that are ultimately inconsistent with an improved and/or maximized throughput of the facility.

Uniquely, the methods and systems herein provide for an objective determination of facility schemes for growing facilities, which are consistent with physical limitations of the facilities and biological limitations of the products introduced therein.

In particular, for a specific growing facility, physical separation of the facility into growth stages, for example, relating to the products introduced therein, objectively impacts throughput of the growing facility, which may be reduced by physical limitations of the facility (e.g., limited facility size, limited workstations, limits on bench movement within the facility, bench position timing, etc.), and also the biological constraints of the products included in the growing facility (e.g., pollination intervals, environmental needs, etc.). The facility scheme for the growing facility is determined herein through the use of objective balancing of throughput and constraints indicative of the above-noted limitations (without limitation), whereby a particular assignment of resources (e.g., greenhouses, benches, etc.) in the growing facility to specific growth stages provides for an improved throughput, while providing efficient physical resource utilization and satisfaction of biological requirements.

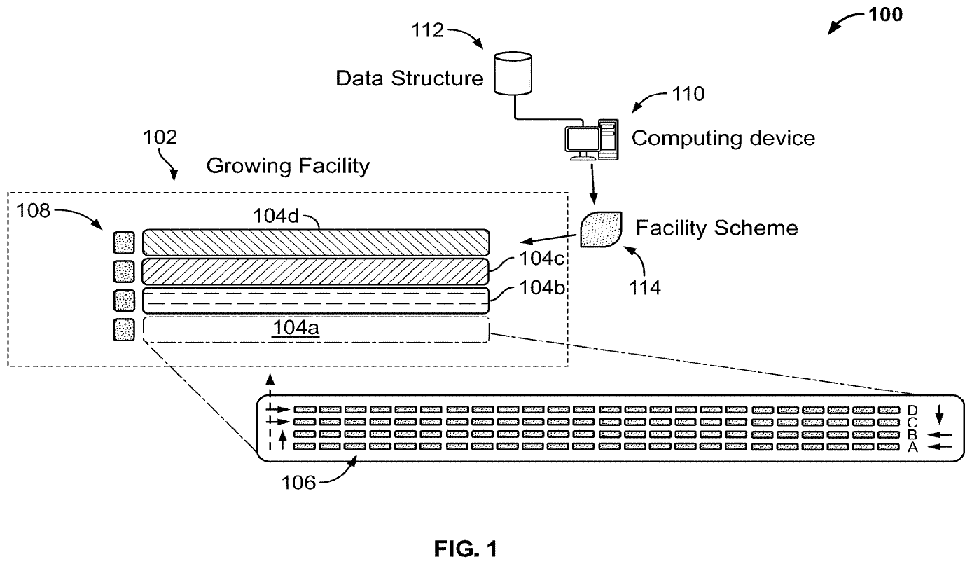

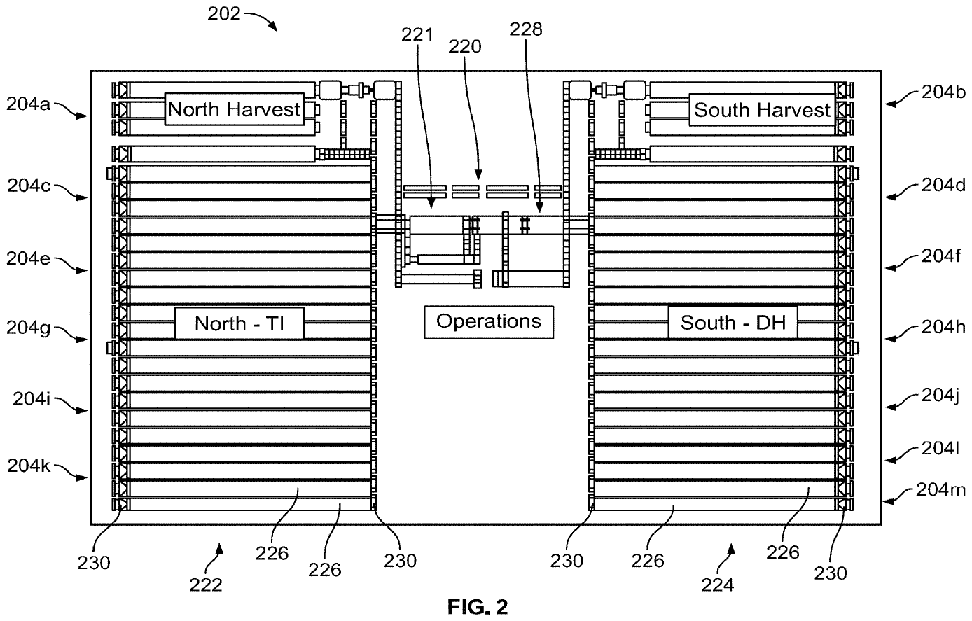

FIG. 1 illustrates an example system 100 for allocating resources within growing spaces (e.g., at a growing facility, etc.), and in which one or more aspects of the present disclosure may be implemented. Although, in the described embodiment, parts of the system 100 are presented in one arrangement, other embodiments may include the same or different parts arranged otherwise depending, for example, on available resources and arrangements of the resources in the growing spaces, etc.

As shown in FIG. 1, the system 100 generally includes a growing facility 102, which may include a variety of different types, sizes, etc., of areas for planting, growing and harvesting crops, etc., in connection with plant advancement trials or otherwise. In this example embodiment, the growing facility 102 is an indoor space. Nonetheless, it should be appreciated that in other system embodiments, the growing facility may include outdoor space(s), or potentially, combinations of indoor space(s) and outdoor space(s).

The growing facility 102 is separated into multiple greenhouses 104a-d, or more broadly, zones. The greenhouses 104a-d, in this example embodiment, are climate-controlled spaces, in which environmental conditions within (and/or associated with) the greenhouses 104a-d are controlled to specific parameters, as desired or required. The environmental conditions may include, for example, temperature, moisture, humidity, solar radiation, wind, etc. Further, the environmental conditions in the greenhouses 104a-d may be controlled independently, such that the temperature in one greenhouse 104a is different than the temperature in another greenhouse 104b, etc. It should be appreciated that different greenhouses may be defined, either by space or by climate-control in other embodiments, whereby different conditions may be extended, or not, to the different greenhouses. In addition, it should be appreciated that one or more of the greenhouses 104a-d may be included in a same or common structure, with the particular environmental conditions for each of the one or more greenhouses 104a-d then set for the particular part of the structure associated with the one or more greenhouses 104a-d.

While only four greenhouses 104a-d are illustrated in the example system 100, it should be appreciated that a different number of greenhouses may be included in other growing facility embodiments. In addition, beyond the number of greenhouses, the arrangement of greenhouses may vary in the facility as well. Further, the number and/or arrangement of conveyors, workstations, etc., in the facility may vary.

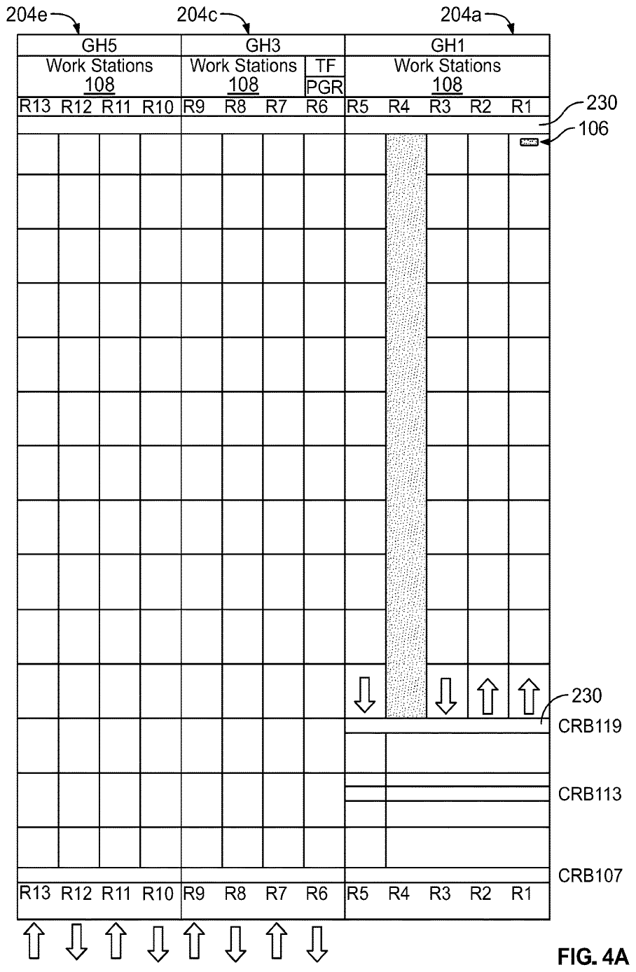

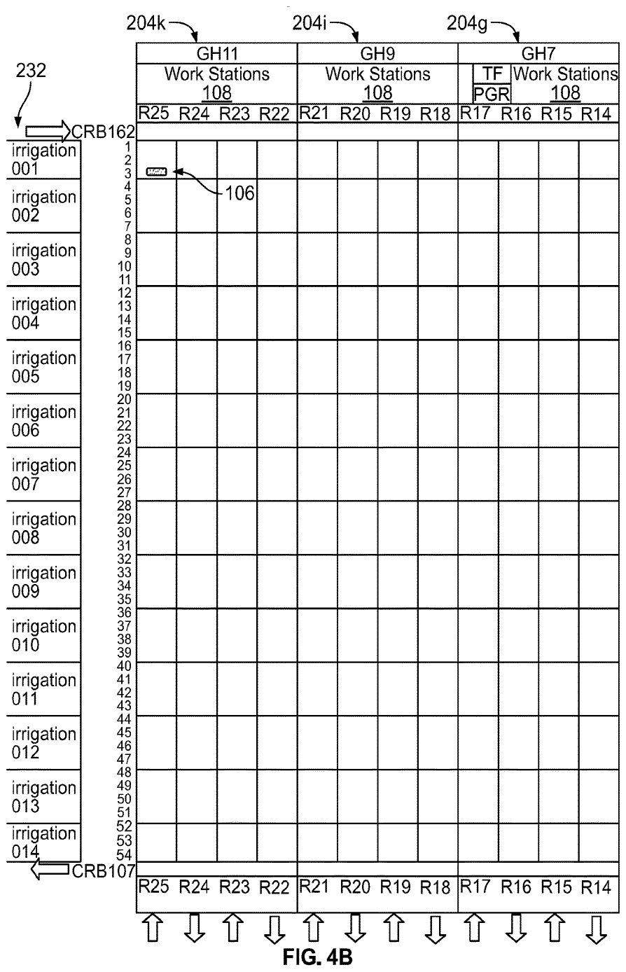

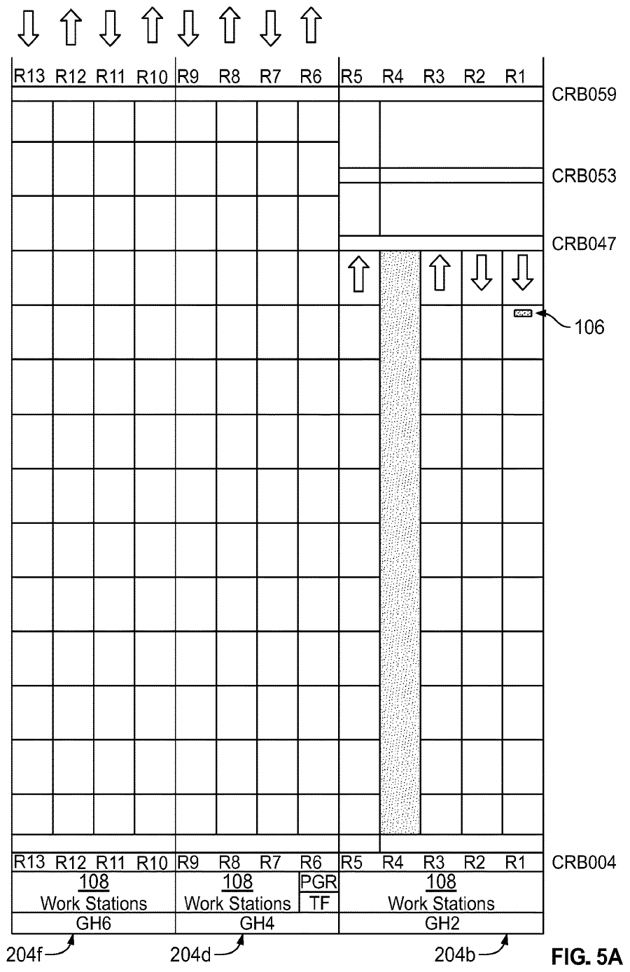

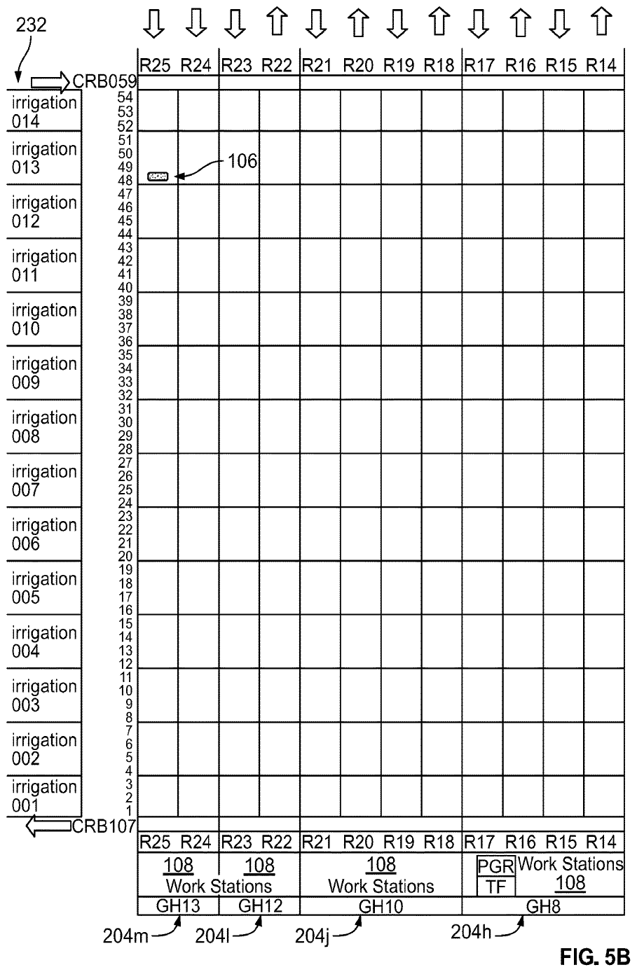

For example, FIGS. 2-5 illustrate an example growing facility 202 that includes thirteen greenhouses 204a-m, disposed in two columns on either side of an operations area 220. In particular in this example, a first side 222 of the growing facility 202 (e.g., a north side as indicated in FIG. 2, etc.) includes six greenhouses 204a, 204c, 204e, 204g, 204i, and 204k configured for a trait integration (TI) workflow. And, a second side 224 of the growing facility (e.g., a south side as indicated in FIG. 2, etc.) includes seven greenhouses 204b, 204d, 204f, 204h, 204j, 204l, and 204m configured for a double haploid (DH) workflow. FIGS. 4A-4B schematically illustrate the six greenhouses 204a (GH1), 204c (GH3), 204e (GH5), 204g (GH7), 204i (GH9), and 204k (GH11) of the first side 222, and FIGS. 5A-5B schematically illustrate the seven greenhouses 204b (GH2), 204d (GH4), 204f (GH6), 204h (GH8), 204j (GH10), 204l (GH12), and 204m (GH13) of the second side 224. Each of the greenhouses 204a-m may be configured for a particular operation in the growing facility 202. For instance, the greenhouses 204a, 204b may include harvesting greenhouses, while other ones of the greenhouses may be used for other operations described herein (e.g., leading up to the harvesting greenhouses whereby plants move through the other greenhouses and then to the harvesting greenhouses, etc.). That said, it should be appreciated that the growing facility 202 may include any desired number of greenhouses, as described and/or determined herein, etc.

With reference again to FIG. 1, each of the greenhouses 104a-d includes benches for holding one or more products in the greenhouses 104a-d. In this embodiment, the greenhouse 104a is shown in detail, as including multiple benches 106. It should be appreciated that the greenhouses 104b-d may be understood to be consistent with greenhouse 104a. Further, in this example, the benches 106 are configured to support seed receptacles or plant receptacles (e.g., pots, trays, multi-well trays, etc.), in various configurations. The number of benches 106, for example, may be based on an overall capacity of the growing facility 102 and/or greenhouse 102a (or other greenhouse 102b-d), or a specific design of the growing facility 102. The benches 106 may also define any suitable size and/or configuration or surface area for holding or supporting a specific number, or a threshold number, of receptacles. For example, the benches 106 in FIG. 1 may be configured to hold a particular number (or desired number) of receptacles, for instance (and depending on the type of receptacle), about one receptacle (e.g., where the receptacle includes a tray configured to hold multiple plants (e.g., a tray configured to hold about fifty or more plants, about one-hundred or more plants, about 128 plants, etc.), about fifty or more receptacles (e.g., where the receptacle includes a pot configured to hold a plant, etc.), about one-hundred or more receptacles, etc. To this point, it should be appreciated that the number of receptacles positioned on the benches 106 may vary depending on, for example, the workflow within the growing facility 102, etc. (e.g., a DH workflow may include about seventy or more pots positioned on a given bench 106 (e.g., seventy-two pots, 108 pots, etc.) while a TI workflow may include less than about seventy pots positioned on a given bench (e.g., about fifty-four pots, etc.), etc.). It should also be appreciated that the benches 106 are generally consistent in size through the growing facility 102 in this embodiment, but may be different in other embodiments.

As shown in FIG. 1, the benches 106 are generally organized in a number of rows and columns (as schematically illustrated for the greenhouse 104a), and the rows and columns of benches 106 may be separated into the different greenhouses 104a-d. In the illustrated embodiment, for example, the greenhouse 104a includes four rows A-D of benches 106 divided into twenty-four columns. That said, a different number of rows and/or columns of benches, generally, may be included in other embodiments.

Referring again to the example growing facility 202 of FIGS. 2-5, each of the greenhouses GH1-GH13 (also identified by reference numbers 204a-m) includes at least one bay, where each bay includes two adjacent rows (identified as R1, R2, R3, etc.). For instance, in the illustrated embodiment, each of greenhouses GH1-GH11 includes two bays, and each of greenhouses GH12-GH13 includes one bay. In addition, each of greenhouses GH1-GH2 includes five rows, each of greenhouses GH3-GH11 includes four rows, and each of greenhouses GH12-GH13 includes two rows. As such, the first side 222 of the growing facility 202 includes twenty-five total rows and the second side 224 of the growing facility 202 includes twenty-five total rows (e.g., with row R4 in each of greenhouses GH1 and GH2 not used and/or blocked off for other use (e.g., for equipment or maintenance needs, etc.), etc.). What's more, each row in the growing facility 202 includes multiple positions extending along a length of the row (e.g., forty-three positions in the illustrated embodiment for each row in greenhouses GH1-GH2 and fifty-four positions in the illustrated embodiment for each row in greenhouses GH3-GH13, etc.). A bench 106, then, is located at each of the positions in each of the rows. And, as described next, each of the benches 106 is moveable through the greenhouses GH1-GH13, from position to position along the rows R1-R25. That said, it should be appreciated that in other example embodiments growing facilities may include different numbers of bays, rows, and/or positions than described above.

With reference to FIG. 1, in this example embodiment, the growing facility 102 includes a level of automation, whereby the benches 106 are mobile, either automatically or manually, from position to position within the corresponding rows. In this particular example, the benches 106 are fixed and/or coupled to one or more conveyors, which, in turn, are configured to move the benches 106 from location to location (or position to position) in the growing facility 102. As shown, in this example, the four rows of benches 106 traverse the greenhouse 104a in the direction indicated by the arrows. The rows A-B traverse the greenhouse 104A from right to left, and the rows C-D traverse the greenhouse from left to right. When the benches 106 in the rows reach the end of the row, one or more conveyors are included and configured to move the benches 106 (as indicated by the arrows) from the row A to the row D, and vice-versa, and from the row B to the row C, and vice-vera. In this manner, the benches 106 in the greenhouse 104a are moved, by the conveyors included therein generally in a loop. The benches 106 in the other greenhouses 104b-d are generally arranged in the same manner, relative to conveyors, which are configured to move the benches 106 in generally the same manner.

In addition to moving the benches 106 from row A to row D, for example, the one or more conveyors are also configured to move the benches 106, at the ends of the rows as shown in FIG. 1, between the different greenhouses 104a-d, as indicated by the dotted arrow. As such, the benches 106 in greenhouse 104a, for example, may be moved, by the conveyors into greenhouse 104b, while the benches from greenhouse 104b are moved, by the conveyors, into the greenhouse 104c, and so on. In this specific embodiment, products are introduced, generally, into the greenhouse 104a and move toward greenhouse 104d over time. A similar description applies to the growing facility 202 and movement of the benches 106 therein (e.g., via conveyors etc. in the directions indicated by the arrows (e.g., where each row in each greenhouse includes a conveyor line, etc.), etc.), for example, in progression on the first side 222 from greenhouse GH1 to greenhouse GH3, to greenhouse GH5, to greenhouse GH7, and so on; and in progression on the second side 224 from greenhouse GH2 to greenhouse GH4, to greenhouse GH6, to greenhouse GH8, and so on.

Consequently, it should be appreciated that movement of the benches 106 in the growing facility 102 (and growing facility 202) is limited by the relative movement of the benches in the individual greenhouses 104a-d of the growing facility 102. Stated another way, the benches 106 in greenhouse 104a are not movable to greenhouse 104d, unless first moved through the greenhouses 104b-c (and displacing the benches 106 disposed therein). It should be appreciated that the greenhouses may be configured otherwise in other system embodiments.

The conveyors are also associated with specific performance, such as, for example, duration, whereby movement of a bench 106 from one position (in the greenhouse 104a, for example) to another position (e.g., in the greenhouse 104a or in the greenhouse 104b, etc.) requires a number of minutes (broadly, requires an amount of time, etc.).

As further shown in FIG. 1, the greenhouses 104a-d also each include one or more workstations 108, which are located at the end of one or more of the rows A-D. In particular, based on the particular configuration of the benches 106, in and among the greenhouses 104a-d, in rows, access to the benches 106 is limited to the ends of the rows a-d, generally. That is, because of the relative positions of rows (and columns) of benches 106, access to a bench in the middle of row D is limited by the benches in row A, for example. As such, human interaction with the seeds/plants disposed at a particular bench is limited to the workstations 108 at one end of the row D in the greenhouse 104a, for example. Similarly, in the example growing facility 202 of FIGS. 2-5, a workstation 108 is located at the end of each of the rows R1-R5, R7-R15, and R18-R25, as indicated. And, irrigation stations (e.g., top flush stations TF, etc.) are located at the end of each of rows R6 and R16-R17. As the benches move through these rows, the irrigation stations operate to top flush the soil to remove accumulated minerals and sediment.

While each of the work stations 108 is positioned at only one end of the rows A-D in greenhouse 104a, it should be appreciated that the work station 108 may include multiple workstations disposed at either end of the specific rows in other embodiments, or only some of the rows in the greenhouse, but not other rows.

In addition to the workstations 108, the growing facility 102 is populated with workers (not shown), which are disposed within the growing space 102 to perform operations, such as, for example, re-arraying, pollination, treatments, harvest, etc. That said, the workers are generally positioned at the workstations 108, whereby the operations, tasks, etc. associated with the growing facility 102 generally take place at the workstations 108 (e.g., the workers may only enter other parts of the growing facility if/when the benches are not moving, etc.). A number of workers are also allocated an interval of time to complete operations. For example, a shift may include eight workers located at four workstations 108 in the greenhouses 104a-d, processing sixteen benches 106, for completing a pollination operation per first interval (e.g., where the first interval is associated with a particular timing for pollination activity (as such activity may be sensitive to a time of day) where a window of pollination may be less than five hours each day (e.g., as the temperatures rises the pollen may not remain viable for pollination, etc.), etc.), a replanting operation within a second interval, etc.

In connection with the above, it should be appreciated that the seeds/plants populated into the growing facility 102 may include one or multiple different types of plants.

In this example embodiment, the growing facility 102 may be populated with corn or maize (Zea mays). However, it should be appreciated that the growing facility 102 may include other plants, including, but not limited to, soybean (Glycine max), cotton (Gossypium hirsutum), peanut (Arachis hypogaea), barley (Hordeum vulgare); oats (Avena sativa); orchard grass (Dactylis glomerata); rice (Oryza sativa, including indica and japonica varieties); sorghum (Sorghum bicolor); sugar cane (Saccharum sp); tall fescue (Festuca arundinacea); turfgrass species (e.g., species: Agrostis stolonifera, Poa pratensis, Stenotaphrum secundatum, etc.); wheat (Triticum aestivum), and alfalfa (Medicago sativa), members of the genus Brassica, including broccoli, cabbage, cauliflower, canola, and rapeseed, carrot, Chinese cabbage, cucumber, dry bean, eggplant, fennel, garden beans, gourd, leek, lettuce, melon, okra, onion, pea, pepper, pumpkin, radish, spinach, squash, sweet corn, tomato, watermelon, honeydew melon, cantaloupe and other melons, banana, castorbean, coconut, coffee, cucumber, Poplar, Southern pine, Radiata pine, Douglas Fir, Eucalyptus, apple and other tree species, orange, grapefruit, lemon, lime and other citrus, clover, linseed, olive, palm, Capsicum, Piper, and Pimenta peppers, sugarbeet, sunflower, sweetgum, tea, tobacco, and other fruit, vegetable, tuber, and/or root crops. The methods and systems herein may also be used in conjunction with non-crop species, especially those used as model methods and/or systems, such as Arabidopsis, etc.

In connection with the above, as the growing facility 102 is configured to include the products from planting to harvest, the products are present within the growing facility 102 during the different growth stages of the products. In particular, products from a set are planted in trays for germination, which are then disposed on benches 106 (e.g., at an operations location of the growing facility 102 (e.g., operations location 220 of the growing facility 202, etc.), etc.), and then, thereafter, planted in individual pots, which are also disposed on benches 106, to progress through a series of growth stages (via the different greenhouses 104a-d) prior to harvesting. For corn, for example, the series of growth stages may include planting, emergence, spraying for pest control, re-arraying, pollination, post pollination and harvesting, etc. In another example, generally, the growth stages (or vegetative stages) may include recovery, growth 1, growth 2, growth 3, pollination, post pollination, and harvest. In this later example, recovery and growth 1 may be assigned to the greenhouse 104a; growth 2 and growth 3 may be assigned to the greenhouse 104b; pollination may be assigned to the greenhouse 104c, and post pollination and harvest may be assigned to the greenhouse 104d. It should be appreciates that a greater or smaller number of growth stages and/or different growth stages may be recognized in other example embodiments. In addition, it should be appreciated that the growth stages may be assigned differently to greenhouses depending, for example, on types of products including in the growing facility 102, a number of greenhouses included in the growing facility 102, etc.

It should be appreciated that the timing of one or more of the growth stages may be dependent on the availability of the products (e.g., seeds, etc.), and also the availability of capacity in the growing facility 102. For example, five or ten varieties of a product may be received at the growing facility 102 over a five week period, whereby the planting of certain products may be delayed or prioritized over other products based on the varieties available/present, etc.

The growth stages generally define timing of specific interaction with the products. For example, a pollination growth stage for a product may require access to the particular product at a particular maturity (e.g., about seven weeks after planting, etc.) and at a particular interval (e.g., three hours in the morning, specifically between 7 AM and 10 AM in the morning, etc.). For instance, corn carries ears and tassels. Pollen from the tassels may then be used to pollinate the ears. However, the ears often develop early. As such, to avoid the ears getting pollinated from random unknown pollen, shoot bags are placed over the ears. As tassels develop, they are covered with tassel bags. Pollen produced is therefore allowed to collect within the tassel bags. When the pollination happens, a pollinator inspects the ears for maturity and pollinates the ears with pollen collected in the tassel bags. That said, corn is monoecious and has both female (shoots) and male flower (tassels) structures on the same plant, but in separate locations. Controlled hand pollinations may therefore be performed by covering the female part of the plant (prior to silk emergence) with a shoot bag, and the male part of the plant (upon flowering) with a paper tassel bag. A plant is then considered pollinated when pollen grains from the tassel are applied to the silk of the shoot, thereby causing fertilization of the ovules, which will develop into corn kernels.

Likewise, re-arraying the products, spaying the products, etc., may also require access to the product, for example, at the workstations 108 (in particular ones of the greenhouses 104a-d) at particular times. In connection with the different stages of the products, the products may also require, without limitations, to be exposed to certain environmental conditions (which may further impact progression of products in growth stages), or separation from certain other products (e.g., in different bays, etc.) (e.g., to prevent cross-contamination at pollination, etc.). For example, the environmental conditions may include, without limitation temperature, humidity, sunlight, etc. More particularly, the recovery stage may utilize cool and dry environmental conditions; the growth stages may each utilize hot environmental conditions (alone or in combination with different humidities, sunlight, etc.); the pollination stage may utilize hot and humid environmental conditions; and the post pollination and harvest stages may utilize hot and dry environmental conditions.

Given the above, in this example embodiment, the system 100 includes a computing device 110, which is configured to generate a facility scheme 114 to be implemented in the growing facility 102, which accounts for the physical features (e.g., limitations, resources, etc.) of the growing facility 102 (e.g., arrangements of benches, arrangements of workstations, arrangements of conveyors, numbers of greenhouses, etc.) and also biological limitations of the products (e.g., particular products to be included in the growing facility 102, etc.).

As part thereof, the computing device 110 is configured to receive and/or retrieve certain data from a data structure 112, where the data is related to the growing facility 102 and/or the products to be introduced therein. The computing device 110 is coupled to the data structure 112, which includes data representative of the growing facility 102 (e.g., conveyor times, row data, column data, workstation data (e.g., indicating location, number, accessibility, usability, etc.), bench data, etc.). In addition, the data structure 112 also includes data related to the products including, without limitation, product growth profiles (e.g., expected growing timing for growth stages (e.g., time spent at each stage and/or timing from planting to harvest, etc.) etc.), environmental condition requirements, schedule of arrival at the growing facility 102, etc. It should be understood, more generally, that data explained or described below may be available in the growing facility 102 in real time, or accessible in the data structure 112, by the computing device 110.

In determining, or generating, the facility scheme 114, the computing device 110 is configured to assign one or more growth stages to each of the greenhouses 104a-d, in this example (e.g., to each of the available greenhouses, to particular ones of the greenhouses, etc.). That is, considering the above, the facility scheme 114 allocates the greenhouses 104a-d, or parts thereof, to specific growth stages to permit, or accommodate, or facilitate, etc. environmental conditions consistent with the growth stages and products therein, while also permitting compatibilities and capacities of resources at the growing facility 102, such as benches 106, and timing to permit specific operations to be performed with respect to biological limitations and/or requirements of the products and physical limitations of the growing facility 102 (e.g., times for sufficient bench space in each bay, conveyor capacity to move benches through required operations, workstation capacity for pollination and other operations and compatibility of plants on benches in near proximity, etc.).

In this example embodiment, the computing device 110 is configured to determine the facility scheme 114, in which greenhouses are assigned to the growth stages, to determine the medium term allocation of growth stages to the greenhouses. In doing so, for instance, the computing device 110 is configured to determine, based on expected seed set arrivals for the next season, the average number of benches 106 of each relative maturity to release each day. The facility scheme 114 is determined to improve or maximizes total throughput of the growing facility 102 and/or to prioritize various seed sets produced subject to the available seed sets.

In connection therewith, the computing device 110 is configured to express the above data (e.g., as included in the data structure 112, etc.) as variables and then to implement an objective function (e.g., model, algorithm, etc.) and associated constraints, as explained below, as indicative of physical and biological limitations or factors relating to plant growth, compatibility and greenhouse infrastructure. In this example embodiment, the computing device 110 is configured to define the facility scheme 114, in which the greenhouse 104a-d, in whole or in part, are designated for specific growth stages of the products therein. In particular, a number of variables, which are descriptive of the growing facility 102 and the greenhouses 104a-d are defined. Table 1, for example, provides a listing of example variables with reference to the above.

TABLE 1

| Variable | Description |
|---|---|
| g | Model greenhouses |
| h | Physical greenhouses (e.g., greenhouses 104a-d, etc.) |
| Hₕ | Set of model greenhouses that belong to the physical |
| | greenhouses |
| i | The growth stage |
| I | The set of growth stage pairs i and i' that cannot be assigned |
| | to same greenhouse |
| S | The set of growth stages that are sensitive to environment |
| j | Plant variety |
| l | Specific pollination plan for variety j |

In addition to the above variables, a number of decision variables are also employed in defining the facility scheme 114, as indicated in Table 2 below, as well as a number of input parameters, as indicated in Table 3 below. The decision variables generally represent decisions made by the objective function/model. And, the input parameters generally represent input data needed to run the objective function/model

TABLE 2

| Variable | Description |
|---|---|
| Bⱼₗ | Number of benches of variety j released per day with pollination |
| | plan l |
| X_{ijg} | 1 if growth stage I of variety j is housed in greenhouse g; 0 |
| | otherwise |
| W_{g} | Number of pollinators available in greenhouse in period t |

TABLE 3

| Variable | Description |
|---|---|
| B^{u} | Upper bound on number of benches released per period |
| ${B}_{j}^{L}$ | lower bound on minimum required number of variety j releases per period |
| cⱼₗ | Expected number of seeds produced if a variety j pot is pollinated |
| | according to plan l |
| C_{g} | Total conveyor time available in greenhouse g per period (day) |
| dᵢⱼ | number of periods that a variety j plant spends in stage i |
| ε | penalty factor to prevent the model from assigning growth stages |
| | to greenhouses unless the associated variety is released at a |
| | positive (> 0) rate |
| K | maximum proportion of bench slots allowed to be filled in a |
| | greenhouse, 0 ≤ K ≤ 1 |
| mᵢⱼ | number of times variety j is moved during stage i per day for |
| | activities (including bagging) other than pollination (period) |
| l^{I}ᵢⱼ(l^{O}ᵢⱼ) | lead time from pot release until initialization (end) of growth |
| | stage i for variety j, l^{I}ᵢⱼ ≥ 0; For instance, if a bench is released in |
| | day 4 of the planning horizon and the growth stage starts in day |
| | l^{I}ᵢⱼ = 2 (after release) and continues until day 1^{O}ᵢⱼ = 4, then that |
| | growth stage would be active in days 6, 7 and 8 |
| ${l}_{j}^{b}$ | lead time for tassel bundling for variety j |
| Pⱼ | number of pots per bench released for variety j, (1 <= Pⱼ <= 108 |
| | and initially set to 54) |
| ${P}_{j}^{u}$ | maximum number of variety j pots that can be released per period |
| πⱼₗ | proportion of periods (days) that a variety j bench is sent to a |
| | workstation for active pollination during its pollination stage if |
| | pollination plan jl is used |
| ρⱼₗ = 0 < ρⱼₗ ≤ 1 | the proportion of pots pollinated on an average day of active |
| | pollination for plan jl conditional on the bench going to a |
| | workstation for pollination |
| ${ρ}_{jlr}^{b}$ | proportion of pots bagged on day r after release for plan jl. |
| tₚ | Average time (hrs) to pollinate a plant |
| t_{c} | Average time (hrs) to cover a plant in prep for pollination (tassel |
| | bundling) |
| tᵣ | average time (hrs) to rotate conveyor to next bench serviced (store |
| | and retrieve) |
| tₗ | average time (hrs) to load or unload a bench from workstation |
| N_{g} | number of workstations available in greenhouse g |
| w | worker time to pollinate a pot (hrs) |
| ${W}_{g}^{U}$ | upper limit on number of workers in greenhouse for workstations |

It should be appreciated that the listing of variables and parameters included in Tables 103 are example in nature. As such, it should also be appreciated that more or less variables and/or parameters associated with, or descriptive of, the growing facility 102 may be employed in other embodiments.

Further to the above, it should be understood that constraints on the objective function may include one or more assumptions made to aid in determining the facility scheme 114. For example, assumptions may include that the growth rate of each product to be included in the growing facility 102 is known and that the length of growth stages is assumed to be deterministic for each product variety but may vary between different product varieties. Additional assumptions may include, without limitation, that a number of pots per bench to be pollinated may vary by product variety; that conveyor speeds and load/unload times are known; that time standards for blocking tassels and pollinating plants are known; that distribution for the number of pots bagged and then pollinated each day during pollination is known for a given bench; that each variety has a fast and slow maturing subvariety with a known maturation rate distribution for shoots and silks; and that the average time to rotate the conveyor to the next bench is known; etc. These and other assumptions, as applicable, may be represented by rules stored in the data structure 112, and the computing device 110 may be configured to retrieve those rules from the data structure 112, in determining the facility scheme 114.

Further to the above, an example objective function is provided below as Equation (1) for use in determining the facility scheme 114. In this example embodiment, the computing device 110 is configured to determine the facility scheme 114 by maximizing, or otherwise optimizing or solving, the seed throughput of the growing facility 102 over a planning horizon (e.g., via the Equation (1), etc.). It should be understood, also, that the objective function presented below (as example Equation (1)) is a mixed linear form having continuous variables (B) and binary variables (X), but may alternatively be non-linear in other example embodiments of the present disclosure.

$$max H = {\sum }_{j} {\sum }_{l} {c}_{jl} {P}_{j} {B}_{j l} - ε {\sum }_{i} {\sum }_{j} {\sum }_{g} {X}_{ijg} \qquad ( 1 )$$

The throughput of the growing facility 102 is measured, in this embodiment, by the number of corn kernels produced each period. A period may include a day, or alternatively, may be a week or other desired length of time (e.g., two days, three days, two weeks, etc.). The throughput is further determined by the product of the number of pots per bench (Pⱼ), kernels per pot obtained if pollination schedule (or propagation plan)/is used on variety j (cⱼₗ), and the number of benches of variety j with pollination schedule/released per period (Bⱼₗ). Constraints on the objective function are defined to limit a number of days of propagation, i.e., a schedule/plan/selected, based on resource capacity. Also, the second term in the Equation (1) is for computational purposes only, in that the term subtracts a small penalty for every assignment of a growth stage to a greenhouse. The term may be omitted in some embodiments, but may be included herein to limit or reduce computation time and/or to simplify the output by limiting the assignment of products that are not released to greenhouses.

As indicated above, the objective function (Equation (1)) may be associated with multiple constraints, including, for example, those specific constraints listed and described below.

Initially, the computing device 110 is configured to use an available pots capacity constraint as expressed in Equation (2), which generally indicates a capacity of the pots available for release to the greenhouses, or more generally, the growing facility 102. The limit is determined by the expected number of products received and germinated of each maturation variety per period. It may be understood that if there is a fast and slow (after re-array) subvariety of each of three varieties, then there are six varieties indexed by j.

$${P}_{j} {\sum }_{l} {B}_{j l} \leq {P}_{j}^{u} ; ∀ j \qquad ( 2 )$$

The computing device 110 is also configured to use a growth stage assignment constraint as defined in Equations (3a)-(3c).

$${\sum }_{g} {X}_{i j g} \leq 1 ; ∀ i , j \qquad ( 3 a )$$

$$M {\sum }_{g} {X}_{i j g} \geq {\sum }_{l} {B}_{j l} ∀ ij \qquad ( 3 b )$$

$${\sum }_{l} {B}_{j l} \geq {B}_{j}^{L} ; ∀ j \qquad ( 3 c )$$

Together, Equations (3a)-(3c) above provide that each growth stage is assigned to exactly one greenhouse if any benches of variety j are released. Growth stages do not need to be assigned if the variety is not produced. M should be understood to be a relatively large number, or sufficient number, which is at least as large as B^{U} or

$$\frac{{P}_{j}^{U}}{{P}_{j}} .$$

Equation (3c) is employed to provide that at least a certain number of variety j benches are released per day if desired.

For environmental purposes it may be desirable to have a growth stage for all, or some subset, of varieties, in the same physical greenhouse. The constraint in Equation (3d) is provided to link or chain each variety to its prior labeled (j−1) variety as a set to provide that a stage i cannot be assigned to different physical greenhouses for both varieties. It should be appreciated that a total set of other varieties may be employed in lieu of Equations (3d) in various embodiments, whereby the constraint is expressed, for example, as provided in Equation (3d′).

$${\sum }_{g ∈ {H}_{h}} {X}_{ijg} + {\sum }_{g ∉ {H}_{h}} {X}_{i , j - 1 , g} \leq 1 ; ∀ i ∈ S , j > 1 , h \qquad ( 3 d )$$

$${\sum }_{g ∈ {H}_{h}} {X}_{ijg} + {\sum }_{g ∉ {H}_{h}} {\sum }_{{j}^{′} \neq j} {X}_{{ij}^{′} g} \leq 1 ; ∀ i ∈ S , j , h \qquad ( 3 {d}^{′} )$$

The constraint in Equation (3e) requires certain pairs of growth stages to be in different physical ones of the greenhouses 104a-d. For each pair i, i′ of such stages, the constraint ensures that those growth stages are assigned to separate physical greenhouses for each variety. Since previous constraints forced all varieties to use the same physical greenhouse for a specific stage, Equation (3e) is only required for at least one variety that will be released, yet including constraints for all varieties is permitted in some embodiments.

$${\sum }_{j ∈ J} {\sum }_{g ϵ {H}_{h}} {X}_{i j g} + {\sum }_{j ∈ J} {\sum }_{g ϵ {H}_{h}} {X}_{{i}^{′} jg} \leq 1 ; ∀ \{ i , {i}^{′} \} ϵ I , h \qquad ( 3 e )$$

A unidirectional flow constraint is provided in Equation (4).

$${X}_{i , j g} \leq {\sum }_{{g}^{′} = 1}^{g} {X}_{i - 1 , {jg}^{′}} ; ∀ i > 1 , j , g \qquad ( 4 )$$

The unidirectional flows constraint forces unidirectional flow through the greenhouses, i.e., as the growth stage increases from i−1 to i the assigned greenhouse either stays the same or is larger. The right hand side of Equation (4) will be 0 if stage i−1 is not assigned to one of the first g greenhouses and 1 if it is assigned to one of the first g greenhouses. Restrictions such as growth stage i must be in the same or immediate next greenhouse than stage i−1 (i.e., no skipping) may be imposed by restricting the range of greenhouses included in the summation to g−1 to g. It should be appreciated that the impact of forced unidirectional flow can be determined by solving the model with and without this constraint and comparing the difference in objective function values.

A conveyor space capacity constraint is provided in Equation (5).

$${\sum }_{i} {\sum }_{j} {\sum }_{l} {d}_{i j} {B}_{j l} {X}_{i j g} \leq 54 ( 2 ) K ; ∀ g \qquad ( 5 )$$

The conveyor space capacity constraint provides that the total number of benches in each greenhouse each period is less than the allowed number. The right hand side of the Equation (5) assumes there are 54 rows per column and 2 columns of benches in each greenhouse, in a particular embodiment. The factor K allows for less than full bench occupancy to facilitate storage during rotation of benches on the conveyor system. The left hand side of Equation (5) accumulates all bench releases that have their growth stage assigned to this greenhouse. That is, the product of the number of days a variety spends in growth stage i times the number of benches released per period of variety j, which is summed over the variety-stage combinations assigned to greenhouse g. The product of the batch release (Bit) and binary assignment (X_{ijg}) variables creates a nonlinearity. Techniques for linearizing this product to facilitate computation are described below.

A conveyor time capacity constraint is provided in Equation (6).

$${\sum }_{i} {\sum }_{j} {\sum }_{l} ( 2 {t}_{l} + {t}_{r} ) {m}_{i j} {d}_{i j} {B}_{j l} {X}_{i j q} \leq {C}_{g} ; ∀ g \qquad ( 6 )$$

The conveyor time capacity constraint provides that a total time on each conveyor is limited per day. The constraint identifies the benches in each greenhouse each period and the number of moves for each bench by type (stage and variety). This is then multiplied by the average time required by the conveyor per move and compared to time available on the conveyor. It is assumed that each move includes a load/unload pair of operations, but may be modified by adjusting the 2tr term. Conveyor rotation time must accommodate time to rotate to store and to retrieve. The constraint is general and does not directly consider pollination. This constraint could be replicated for vertical and horizontal conveyors as needed if the limiting capacity conveyor is not known.

A conveyor time capacity for pollination constraint is provided in Equation (7).

$${\sum }_{j} {\sum }_{l} ( 2 {t}_{l} + {t}_{r} ) {π}_{j l} {d}_{[ p ] j} {B}_{j l} {X}_{[ p ] j g} \leq ( 3 ) ; ∀ g \qquad ( 7 )$$

The conveyor time capacity for pollination constraint ensures that all pollination moves can happen within an interval at a specific time of day (e.g., a three hour time frame each day (period), etc.) based on conveyor capacity. The left hand side of the Equation (7) accumulates the conveyor time per move for pollination multiplied by the number of benches in the greenhouse of variety j that are in the pollination stage, and finally by the probability those benches will be pollinated on a given period (day). The constraint is activated for the pollination stage [p] associated with variety j.

A workforce pollination capacity constraint is provided in Equation (8).

$${\sum }_{j} {\sum }_{l} ( 2 {t}_{l} {W}_{g} + {wP}_{j} {ρ}_{j l} ) {π}_{j l} {d}_{[ p ] j} {B}_{jl} {X}_{[ p ] j g} \leq 3 {W}_{g} ; ∀ g \qquad ( 8 )$$

The workforce pollination capacity constraint provides that all pollination can happen within the above interval (e.g., a three hour window each period, etc.), given workforce pollinator capacity. The left hand side of the Equation (8) accumulates worker time required and the right hand side of the Equation (8) indicates the number of worker hours available during the interval (e.g., the three hour window, etc.). It assumes workers are busy in unloading and loading the conveyor. The format is similar to the previous constraint except time per bench pollinated is the load/unload time plus the worker pollination time for pots pollinated in a bench. There is an assumption that all pollinators assigned to a workstation are occupied during load/unload.

The nonlinearity induced by including the W_{gt} term on the left hand side of Equation (8) can be eliminated by estimating the time spent in load/unload versus pollination and adjusting the interval (e.g., 3 hours, etc.) available on the right hand side of Equation (8) downwards accordingly.

A workstation pollination time constraint is provided in Equation (9)

$${\sum }_{j} {\sum }_{l} ( 2 {t}_{l} + w {P}_{f} {ρ}_{j l} ) {π}_{j l} {d}_{[ p ] j} {B}_{j τ} {X}_{[ p ] j g} \leq 3 {N}_{g} ; ∀ g \qquad ( 9 )$$

The workstation pollination time constraint provides for sufficient chronological time in available workstations to complete pollination each period. The right hand side of Equation (9) represents the interval, i.e., a 3-hour daily time window, in this example, for pollination multiplied by the number of workstations in the greenhouse. It is similar to the constraint of Equation (8) except the number of workers is replaced by the number of workstations. As before, the constraint assumes the associated load/unload times occupy workstation time.

And further, a variable type and range definition is provided in Equation (10).

$${X}_{i j g} ∈ \{ 0 , 1 \} {B}^{u} \geq {B}_{j l} \geq 0 ; {W}_{gt}^{U} \geq {W}_{gt} \geq 0 \qquad ( 10 )$$

A vacant count of greenhouses is associated with two constraints for each type of limit to be activated, as required. Initially, for a limit that any two bays in the growing facility 102 are vacant, the constraint is consistent with Equations (11a)-(11b) where M′ is a large number at least as large as the product of stages and varieties, and for a limit that two bays in the same greenhouse 104 are vacant, the constraint is consistent with Equations (12a)-(12b), where Z_{g}=1 if greenhouse g is used and 0 otherwise.

$${\sum }_{i} {\sum }_{j} {X}_{i j g} \leq {M}^{′} {Z}_{g} ∀ g \qquad ( 11 a )$$

$${\sum }_{g} {Z}_{q} \leq 8 \qquad ( 11 b )$$

$${\sum }_{i} {\sum }_{j} {X}_{i j g} + {\sum }_{i} {\sum }_{j} {X}_{{ijg}^{′}} \leq 2 {M}^{′} {Z}_{h} ; ∀ ( g , {g}^{′} ) ∈ {H}_{h} \qquad ( 12 a )$$

$${\sum }_{h} {Z}_{h} \leq 3 \qquad ( 12 b )$$

It should be appreciated that, based on the above, nonlinearity in the overall model (of which the objective function is a part) relates to the product of the batch release variables (B) and stage-to-greenhouse assignment variables (X). As there is an upper bound on the number of batches that can be released in a day, the model can be linearized using standard techniques as shown below.

To linearize the product of a binary variable X and continuous (or integer variable) B, a new variables Z is imposed, where Z=XB. Let B^{u} be an upper bound on B. Then add the following constraints, where, for example for the specified greenhouse it likely suffices to set B^{u}=8:

$$Z \leq {B}^{u} X$$

$$Z \leq B$$

$$Z \geq B - ( 1 - X ) {B}^{u}$$

$$Z \geq 0$$

In connection with the above, the number of benches 106 released is a continuous variable. The interpretation of fractional amounts would be the probability a bench is released each period so that the number is correct on average. For instance, in one example, if B=1.5, that would suggest releasing on batch one day and two batches the next day, following with this alternating pattern. Alternatively, the number of benches 106 could be modeled as an integer.

Furthermore, in connection with the above, K may be Kg to allow different levels of conveyor occupation in the greenhouse 104a-d. For example, different levels of occupation may be appropriate for instance in which certain conveyors are more utilized than others due to, for example, pollination. The tᵣ then becomes t_{rg} if the different levels of occupation are used to provide the conveyor occupancy versus rotation time to an open slot tradeoff. If a lower bound on the number of benches 106 exists for specific varieties the following constraint could be added

$${\sum }_{l} {B}_{j l} \geq {B}_{j}^{min} , ∀ j where {B}_{j}^{min}$$

is the minimum number of benches required per day for variety j. This is used when certain benches 106 are desired for a product variety that may have a low yield. Further still, through use of the growing facility 102, physical limitations, such as, for example, average move times and conveyor congestion are observed, and imposed back into the constraints to improve accuracy of the computing device 110, whereby the facility scheme 114 is determined through iteration until a sufficient or acceptable facility scheme is identified (e.g., balance between accuracy of the limitations and throughput of the growing facility 102, etc.)

In connection with the above, in the illustrated embodiment, the workstations 108 are associated with specific conveyors, and not specific ones of the greenhouses 104a-d, whereby it may be preferable to model conveyors instead of greenhouses 104a-d. Also, for more flexibility in how benches 106 move from one conveyor to another in a greenhouse 104a, for example, growth stages may be divided into substages. In such an example, pollination may be pollination A and pollination B with the total time adding up to the actual time for the pollination growth stage. This optional granularity may provide for additional throughput in certain embodiments.

In view of the above, in the example embodiment of FIG. 1, the computing device 110 is configured to determine the facility scheme 114 from the above equations and constraints and parameters. The output, then, is in a form of a number of greenhouses required per stage to provide a desired throughput (e.g., to maximize throughput, etc.), given that different pots spend a different number of days in different stages. Once determined, the computing device 110 is configured to implement the facility scheme 114 in the growing facility 102. As shown in FIG. 1, for example, each of the greenhouses 104a-d includes a different pattern or hatching, which is indicative of the growth stage implemented for the corn crop (e.g., and assigned to a particular one of the greenhouses 104a-d or a particular part thereof, etc.). For example, no pattern of greenhouse 104a includes a planting growth stage for the corn products, and the horizontal dashes of greenhouse 104b indicate a transplanting growth stage, while the angled lines of greenhouse 104c indicate a pollination growth stage and the brick pattern of the greenhouse 104d indicates a harvest growth stage. It should be understood that the growth stages implemented in the greenhouses 104a-d in FIG. 1 are for purposes of illustration and should not be understood to limit the facility scheme 114 determined by the computing device 110 or otherwise.

FIGS. 2-5, as explained above, illustrate example growing facility 202. As shown, the growing facility 202 includes a different number of greenhouses (and which may be implemented (e.g., designed, laid out, constructed, arranged, etc.) in the growing facility 102 of FIG. 1, for example, based on the determined facility scheme 114). As shown in FIG. 2, the example facility scheme for the growing facility 202 includes the thirteen greenhouses 204a-m, disposed in two columns on either side of operations area 220 (e.g., the first side 222, or north side; and the second side 224, or south side; etc.). In particular in this example, the first side 222 of the growing facility 202 includes six greenhouses 204a, 204c, 204e, 204g, 204i, and 204k. And, the second side 224 of the growing facility includes seven greenhouses 204b, 204d, 204f, 204h, 204j, 204l, and 204m.

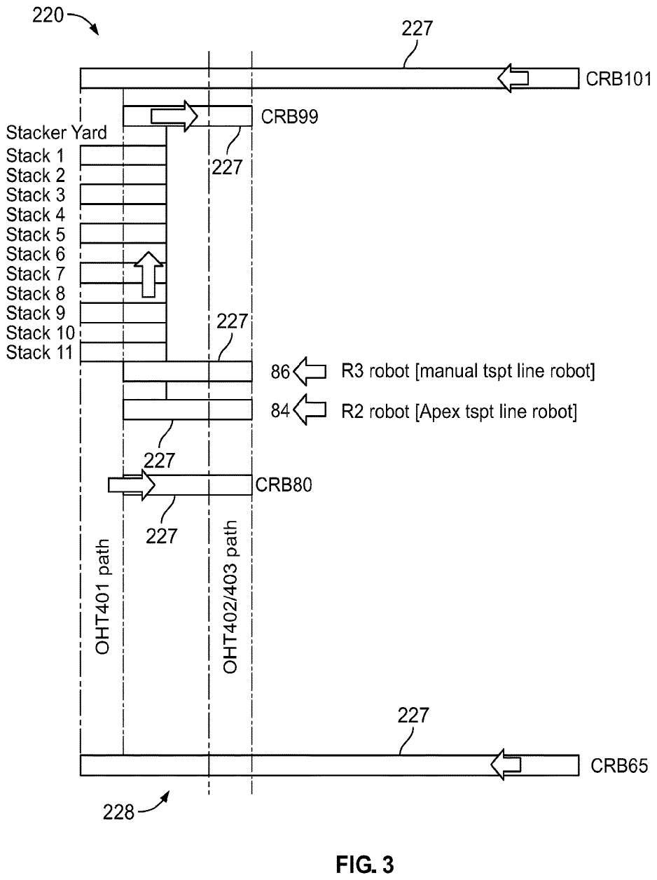

As shown in FIGS. 2 and 3, the operations area 220 is disposed generally between the first side 222 and the second side 224, and includes controls for controlling operations of the greenhouses 204a-m. In connection therewith, in this example embodiment, the operations area 220 includes various automated equipment 221 including, for example, automated planting and transplanting equipment, soil mixing and distributing equipment, DH lab equipment, and germination chambers for use in performing one or more operations on the plants in the growing facility 202. As such, the operations area 220 may be used for seed planting, DH lab treatment, germination, and transplanting plants into pots. The pots, then, may be placed onto benches 106 and accumulated, for example, at a stacker yard, via conveyors 227 of a transport system 228, and then transferred to the greenhouses 204a-m (e.g., via one or more cranes of the transport system 228, etc.). In doing so, the transport system 228 generally includes multiple conveyors and robotic equipment configured to move the pots, benches, etc. as needed. In one particular example, seeds may be planted in germination trays in the operations area 220, and may then remain in germination rooms (in the operations area 220) until they are ready to be transplanted (re-planted) into pots and loaded onto benches 106 (also in operations area 220). Then, the benches 106, filled with the pots, are moved by cranes and conveyors of the transport system 228 to one or more of the greenhouses (e.g., to greenhouse 204k, 204m, etc.).

FIGS. 4A-4B schematically illustrate the six greenhouses 204a (GH1), 204c (GH3), 204e (GH5), 204g (GH7), 204i (GH9), and 204k (GH11) of the first side 222. And, FIGS. 5A-5B schematically illustrate the seven greenhouses 204b (GH2), 204d (GH4), 204f (GH6), 204h (GH8), 204j (GH10), 204l (GH12), and 204m (GH13) of the second side 224. Each of the greenhouses GH1-GH13 includes at least one bay, where each bay includes two adjacent rows (identified as R1, R2, R3, etc. in the figures). For instance, in the illustrated embodiment, each of greenhouses GH1-GH11 includes two bays, and each of greenhouses GH12-GH13 includes one bay. In addition, each of greenhouses GH1-GH2 includes five rows, each of greenhouses GH3-GH11 includes four rows, and each of greenhouses GH12-GH13 includes two rows. As such, the first side 222 of the growing facility 202 includes twenty-five total rows and the second side 224 of the growing facility 202 includes twenty-five total rows (e.g., with row R4 in each of greenhouses GH1 and GH2 not used and/or blocked off for other use, etc.).

What's more, each row in the growing facility 202 includes multiple positions extending along a length of the row (e.g., forty-three positions in the illustrated embodiment for each row in greenhouses GH1-GH2 and fifty-four positions in the illustrated embodiment for each row in greenhouses GH3-GH13, etc.) (see, FIGS. 4B and 5B). A bench 106, then, is located at each of the positions in each of the rows. Each of the benches 106 is moveable through the greenhouses GH1-GH13, from position to position along the rows R1-R25. For instance, in this example, the benches 106 are fixed and/or coupled to conveyors 226, which, in turn, are each configured to move the benches 106 from location to location (or position to position) within each of the bays, rows, etc. of the given greenhouses GH1-GH13 of the growing facility 102. As such, in greenhouse 204a (GH1) (FIG. 4A), for example, the four rows of benches 106 therein (in rows R1, R2, R3, and R5) traverse the greenhouse 204a in the direction indicated by the arrows, via corresponding conveyors 226 disposed within each of the rows. The rows R1 and R2 traverse the greenhouse 104A from bottom to top, and the rows R3 and R5 traverse the greenhouse from top to bottom. When the benches 106 in the rows R1 and R2 reach the end of the row, lateral conveyors 230 are included and configured to move the benches 106 between desired rows, for example, from the row R1 to row R5 and from the row R2 to the row R3 (and vice-versa when the benches 106 reach the end the rows R3 and R5). In this manner, the benches 106 in the greenhouse 204a are moved, by the conveyors 226, 230 included therein, generally in a loop. The benches 106 in the other greenhouses 204b-m are generally arranged in the same manner, relative to conveyors, which are configured to move the benches 106 in generally the same manner. In addition to moving the benches 106 between the rows in the greenhouse 204a, conveyors are also configured to move the benches 106, at the ends of the rows (e.g., at the ends of the rows R1 and R2, etc.), from the greenhouse 204a to the greenhouse 204c, and so on.

As further shown in FIGS. 4A-5B, the greenhouses 204a-m also include workstations 108, which are located at the end of rows therein. In particular, based on the particular configuration of the benches 106, in and among the greenhouses 204a-m, in rows, access to the benches 106 is limited to the ends of the rows, generally. That is, because of the relative positions of rows (and columns) of benches 106, access to a bench in the middle of a row in a greenhouse may be limited by benches in adjacent rows, for example. In the illustrated embodiment, the greenhouses 204a-m each include at least one workstation 108 (e.g., one workstation 108, two workstations 108, three workstations 108, four workstations 108, etc.). In addition, in the illustrated embodiment greenhouses 204c, 204d, 204g, and 204h each include at least one specialized workstation 108 configured for use with plant growth regulator (PGR) and the top flushing (TF) activities described above. The TF activities may include, for example, top flushing the soil in the benches 106, using an irrigation station, etc., as the benches move through these rows of these greenhouses in order to remove accumulated minerals and sediment. And, the PGR activities may include overhead spraying activities (whereby the PGR may include an overhead sprayer, etc.) relating to one or more treatments (e.g., nutrient treatments, pesticides, etc.) configured to enhance, protect, feed, etc. the plants in the pots on the benches 106 (e.g., based on a particular time the plants have been in the growing facility 202 (e.g., around day 35 in the facility 202, etc.), about one week after re-array, etc.).

In view of the above, the example growing facility 202 may thus accommodate, for instance, upwards of about 75,000 or more individual products, from planting to harvest.

In this example, the growing facility 202 also includes multiple irrigation feeds 232 adjacent the greenhouses (see, FIG. 4B including irrigation feeds 001-014 adjacent greenhouse GH11, and FIG. 5B including irrigation feeds 001-014 adjacent greenhouse GH13). In this example, each of the irrigation feeds includes an ebb and flood irrigation system configured to irrigate the plants disposed on the benches 106 (e.g., about four benches at a time, more than four benches at a time, fewer than four benches at a time, etc.) at a time. It is an ebb and flood irrigation system.

With reference again to FIG. 1, in addition to implementing the growth stages, the computing device 110 is configured to implement environmental conditions, by control of the greenhouses 104a-d, which are consistent with the growth stages implemented in the greenhouses 104a-d. For example, the computing device 110 may impose a first temperature in the planting greenhouse 104a, and a second different temperature in the harvesting greenhouse 104d. It should be appreciated that the particular environmental conditions implemented by the computing device 110 may be specific to the growth stage, product and/or capabilities/capacities of the greenhouses, etc.

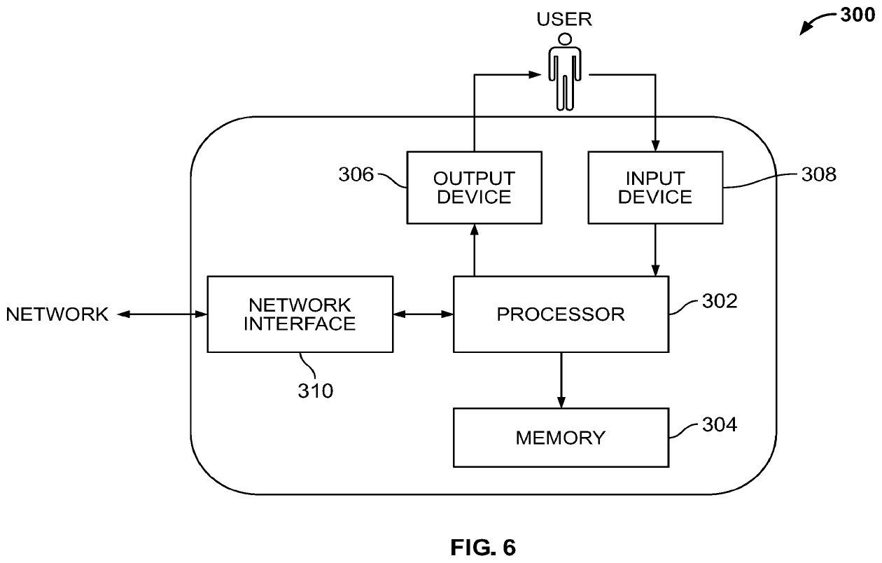

FIG. 6 illustrates an example computing device 300 that may be used in the system 100, for example, in connection with the computing device 110 and/or the data structure 112, etc., whereby each includes and/or is implemented in at least one computing device consistent with computing device 300. In connection therewith, the computing device 300 may be uniquely, or specifically, configured, by executable instructions, to implement the various algorithms and other operations described herein with regard to the computing device 110. It should be appreciated that the system 100, as described herein, may include a variety of different computing devices, either consistent with computing device 300 or different from computing device 300.

The example computing device 300 may include, for example, one or more servers, workstations, personal computers, laptops, tablets, smartphones, other suitable computing devices, combinations thereof, etc. In addition, the computing device 300 may include a single computing device, or it may include multiple computing devices located in close proximity or distributed over a geographic region, and coupled to one another via one or more networks. Such networks may include, without limitations, the Internet, an intranet, a private or public local area network (LAN), wide area network (WAN), mobile network, telecommunication networks, combinations thereof, or other suitable network(s), etc. In one example, the data structure 112 of the system 100 includes at least one server computing device, while the computing device 110 includes at least one separate computing device, which is coupled to the data structure 112, directly and/or by one or more LANs, etc.

With that said, the illustrated computing device 300 includes a processor 302 and a memory 304 that is coupled to (and in communication with) the processor 302. The processor 302 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above listing is example only, and thus is not intended to limit in any way the definition and/or meaning of processor.

The memory 304, as described herein, is one or more devices that enable information, such as executable instructions and/or other data, to be stored and retrieved. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, tapes, hard disks, and/or any other type of volatile or nonvolatile physical or tangible computer-readable media.

The memory 304 may be configured to store, without limitation, product schedules, growth stage profile per product, environmental conditions, conveyor time, and/or other types of data (and/or data structures) suitable for use as described herein, etc. In various embodiments, computer-executable instructions may be stored in the memory 304 for execution by the processor 302 to cause the processor 302 to perform one or more of the functions described herein, such that the memory 304 is a physical, tangible, and non-transitory computer-readable storage media. Such instructions often improve the efficiencies and/or performance of the processor 302 that is performing one or more of the various operations herein (e.g., one or more operations of method 400, etc.) whereby such performance may transform the computing device 300 into a special-purpose computing device. It should be appreciated that the memory 304 may include a variety of different memories, each implemented in one or more of the functions or processes described herein.

In the example embodiment, the computing device 300 also includes an output device 306 that is coupled to (and is in communication with) the processor 302. The output device 306 outputs, or presents, to a user of the computing device 300 (e.g., a facility operator, etc.) by, for example, displaying and/or otherwise outputting information such as, but not limited to, the facility scheme 114, etc. It should be further appreciated that, in some embodiments, the output device 306 may comprise a display device such that various interfaces (e.g., applications (network-based or otherwise), etc.) may be displayed at computing device 300, and in particular at the display device, to display such information and data, etc. And in some examples, the computing device 300 may cause the interfaces to be displayed at a display device of another computing device, including, for example, a server hosting a website having multiple webpages, or interacting with a web application employed at the other computing device, etc. Output device 306 may include, without limitation, a liquid crystal display (LCD), a light-emitting diode (LED) display, an organic LED (OLED) display, an “electronic ink” display, combinations thereof, etc. In some embodiments, output device 306 may include multiple units.

The computing device 300 further includes an input device 308 that receives input from the user (e.g., an implementation command for a facility scheme from a facility operator, etc.). The input device 308 is coupled to (and is in communication with) the processor 302 and may include, for example, a keyboard, a pointing device, a mouse, a stylus, a touch sensitive panel (e.g., a touch pad or a touch screen, etc.), another computing device, and/or an audio input device. Further, in some example embodiments, a touch screen, such as that included in a tablet or similar device, may perform as both output device 306 and input device 308. In at least one example embodiment, the output device 306 and the input device 308 may be omitted.

In addition, the illustrated computing device 300 includes a network interface 310 coupled to (and in communication with) the processor 302 (and, in some embodiments, to the memory 304 as well). The network interface 310 may include, without limitation, a wired network adapter, a wireless network adapter, a telecommunications adapter, or other devices capable of communicating to one or more different networks. In at least one embodiment, the network interface 310 is employed to receive inputs to the computing device 300. In some example embodiments, the computing device 300 may include the processor 302 and one or more network interfaces incorporated into or with the processor 302.

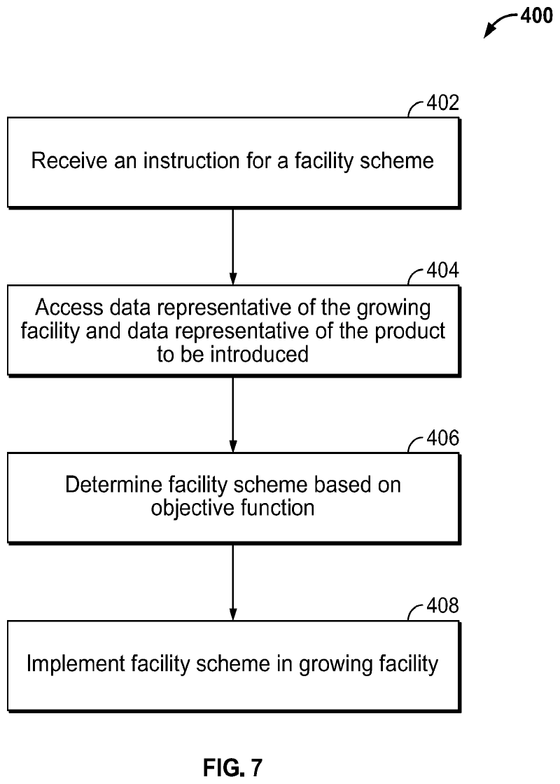

FIG. 7 illustrates an example method 400 of determining a facility scheme for a growing facility. The example method 400 is described herein in connection with the system 100, and may be implemented, in whole or in part, in the computing device 110 of the system 100. Further, for purposes of illustration, the example method 400 is also described with reference to the computing device 110, the data structure 112, and more generally, the system 100 (and the growing facility 102 of the system 100), and also the computing device 300 of FIG. 6. However, it should be appreciated that the method 400, or other methods described herein, are not limited to the system 100, the distributions in FIG. 2, or the computing device 300. And, conversely, the systems, data structures, and computing devices described herein are not limited to the example method 400.

At the outset in method 400, it should be appreciated that relevant data related to the growing facility 102, the product(s) at the growing facility 102, etc., is stored and accessible in the data structure 112.

Initially, then, at step 402, an instruction is received to determine a facility scheme 114 for the growing facility 102. The instruction may be received, for example, from a facility operator or another user associated with the growing facility 102. The instruction may include an indication, either directly or by reference (e.g., in the data structure 112, etc.), an indication of the products to be introduced into the growing facility 102 and a schedule of receipt of the products from a current day to a day in the future, prior to a planning horizon for the facility scheme 114. The instruction may be received, from time to time, but, in general, will be received at the beginning of a growing session, which may extend for a period of months, a year or more or less, etc.

It should be understood that the instruction may include or reference any suitable data to be used in determining the facility scheme 114.

At 404, the computing device 110 accesses the data relevant to the facility scheme 114 in the data structure 112 (or elsewhere as required or desired). The data, for example, may be consistent with the variables listed in Tables 1-3, above, and otherwise, as defined or referenced in the equations and/or constraints described above.

The computing device 110 then determines, at 406, the facility scheme 114 for the growing facility 102, based on the accessed data, the objective function in Equation (1), and the assumptions/constraints described herein. The objective function provides a score or result, per facility scheme, for which the facility scheme provides a maximum, optimum, or desired throughput, relative to the throughput of other facility schemes.

At 408, the computing device 110 implements the facility scheme 114, by assigning the growing facility 102 (and/or resources of the growing facility 102) consistent with the facility scheme 114. In connection therewith, the different greenhouses of the growing facility 102 (or the growing facility 202) are associated growth stages of the product(s) to be included in the growing facility. For example, with reference to the growing facility 102 of FIG. 1, based on the generated facility scheme 114, the four greenhouses 104a-d may be assigned or arranged within the growing facility 102 (in order to accommodate the particular product(s) desired for the given facility scheme 114). In addition, the greenhouse 104a may be assigned a planting growth stage; the greenhouse 104b may be assigned a transplanting growth stage; the greenhouse 104c may be assigned a pollination growth stage; and the greenhouse 104d may be assigned a harvest growth stage. Further, each of the greenhouses 104a-d may also be assigned (or configured with, etc.) a particular number of rows/bays, locations, benches, workstations, and conveyors, etc. in accordance with the generated facility scheme 114, and then constructed, fitted, etc. therewith as appropriate.

In view of the above, the methods and systems herein provide for an objective determination of facility schemes for growing facilities, a desired (e.g., optimal, maximum, etc.) output obtainable for those facilities and operational plans necessary to achieve that desired output, consistent with physical limitations (e.g., resources, characteristics, configurations, etc.) of the facilities and biological characteristics, attributes, etc. of the products introduced and processed therein. In this manner, a substantial number of factors may be considered, generally simultaneously, in the design of the growing facilities and the allocation of resources to different growth stages associated with plants disposed in the growing facilities, including, for example, timelines, inflow of products, product arrival schedules, physical locations of the growing facilities, product output demand for the growing facilities, environmental compatibility between growth stages and plant varieties, operational characteristics of transport mechanisms, configuration and capacity of work areas, etc., thereby integrating thousands, or tens of thousands, or more, decisions based on those variables, into a comprehensive design of the growing facilities in a way that is beyond what is conventional though human design of like facilities.

In this way, in one particular example, the methods and systems herein may provide for determining an optimal, maximum, desired, etc. capacity of a growing facility, with (or in view of) the specified resources available at the growing facility, to yield a harvested product (e.g., corn, etc.).

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) in response to an instruction, accessing data representative of a growing facility and data representative of a product to be introduced into the growing facility, the growing facility including multiple greenhouses, the product including multiple growth stages; (b) determining a facility scheme, in which ones of the multiple growth stages are assigned to ones of the multiple greenhouses, based on the accessed data and an objective function; (c) implementing the facility scheme at the growing facility; and/or (d) receiving the instruction from a facility operator of the growing facility, the instruction including an indication of the product.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and “at least one of” includes any and all combinations of one or more of the associated listed items.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for allocating resources in a growing facility, the method comprising:
in response to an instruction, accessing, by a computing device, data representative of a growing facility and data representative of a product to be introduced into the growing facility, the growing facility including multiple greenhouses, the product including multiple growth stages;
determining, by the computing device, a facility scheme, in which ones of the multiple growth stages are assigned to ones of the multiple greenhouses, based on the accessed data and an objective function; and
implementing, by the computing device, the facility scheme at the growing facility.

2. The method of claim 1, further comprising receiving the instruction from a facility operator of the growing facility, the instruction including an indication of the product; and
wherein the product includes one or more varieties of corn.

3. The method of claim 1, wherein each of the multiple greenhouses includes multiple rows of benches moveable to and from one or more workstations; and/or
wherein the benches are moveable between different ones of the multiple greenhouses; and/or
wherein the greenhouses include conveyors to move the benches within each of the multiple greenhouse and between the multiple greenhouses.

4. The method of claim 1, wherein the objective function is consistent with:
$$max H = {\sum }_{j} {\sum }_{l} {c}_{j l} {P}_{j} {B}_{jl} ,$$
where Pⱼ is the number of pots per bench of variety j, cⱼₗ is the number of kernels per pot obtained based on pollination schedule/for the variety j, and Bⱼₗ is the number of benches of variety j with pollination schedule/released per period.

5. (canceled)

6. The method of claim 1, wherein implementing the facility scheme at the growing facility includes:
planting the product in one or more receptacles at the growing facility; and
introducing the one or more receptacles to one or more of the multiple greenhouses of the growing facility.

7. The method of claim 6, further comprising moving, via one or more conveyors, the one or more receptacles between different ones of the greenhouses of the growing facility.

8. The method of claim 6, further comprising moving, via one or more conveyors, the one or more receptacles along a row within the one or more of the multiple greenhouses of the growing facility.

9. A system for allocating resources in a growing facility, the system comprising at least one computing device configured to:
in response to an instruction, access data representative of a growing facility and data representative of a product to be introduced into the growing facility, the growing facility including multiple greenhouses, the product including multiple growth stages;
determine a facility scheme, in which ones of the multiple growth stages are assigned to ones of the multiple greenhouses, based on the accessed data and an objective function; and
implement the facility scheme at the growing facility.

10. The system of claim 9, wherein the at least one computing device is further configured to receive the instruction from a facility operator of the growing facility, the instruction including an indication of the product; and
wherein the product includes one or more varieties of corn.

11. The system of claim 9, wherein each of the multiple greenhouses includes multiple rows of benches moveable to and from one or more workstations; and/or
wherein the benches are moveable between different ones of the multiple greenhouses; and/or
wherein the greenhouses include conveyors to move the benches within each of the multiple greenhouse and between the multiple greenhouses.

12. The system of claim 9, wherein the objective function is consistent with:
$$max H = {\sum }_{j} {\sum }_{l} {c}_{j l} {P}_{j} {B}_{jl} ,$$
where Pⱼ is the number of pots per bench of variety j, cⱼₗ is the number of kernels per pot obtained based on pollination schedule/for the variety j, and Bⱼₗ is the number of benches of variety j with pollination schedule/released per period.

13. (canceled)

14. The system of claim 9, further comprising the growing facility.

15. The system of claim 14, wherein the growing facility includes at least one greenhouse.

16. The system of claim 15, wherein the at least one greenhouse includes a conveyor and multiple benches coupled to the conveyor, wherein the conveyor is configured to move the multiple benches through the at least one greenhouse.

17. The system of claim 16, wherein the at least one greenhouse includes multiple containers, the product included in the multiple containers.

18. The system of claim 15, wherein the at least one greenhouse defines at least one row, the conveyor configured to move the benches along the at least one row; and
wherein the at least one greenhouse includes at least one workstation disposed toward an end portion of the at least one row.

19. A non-transitory computer-readable storage media including executable instructions for use in allocating resources in a growing facility, which, when executed by at least one processor, cause the at least one processor to:
in response to an instruction to the at least one processor, access data representative of a growing facility and data representative of a product to be introduced into the growing facility, the growing facility including multiple greenhouses, the product including multiple growth stages;
determine a facility scheme, in which ones of the multiple growth stages are assigned to ones of the multiple greenhouses, based on the accessed data and an objective function; and
implement the facility scheme at the growing facility.

20.-21. (canceled)

22. The non-transitory computer-readable storage medium of claim 19, wherein the objective function is consistent with:
$$max H = {\sum }_{j} {\sum }_{l} {c}_{j l} {P}_{j} {B}_{jl} ,$$
where Pⱼ is the number of pots per bench of variety j, cⱼₗ is the number of kernels per pot obtained based on pollination schedule/for the variety j, and Bⱼₗ is the number of benches of variety j with pollination schedule/released per period.

23. (canceled)

24. The non-transitory computer-readable storage medium of claim 19, wherein the executable instructions, when executed by the at least one processor to implement the facility scheme at the growing facility, cause the at least one processor to actuate one or more conveyors to move the product between different ones of the multiple greenhouses based on the determined facility scheme.

25. The non-transitory computer-readable storage medium of claim 19, wherein the executable instructions, when executed by the at least one processor to implement the facility scheme at the growing facility, cause the at least one processor to actuate one or more conveyors to move the product along a row within one or more of the multiple greenhouses based on the determined facility scheme.
